(19) United States
(12) Patent Application Publication
(10) Pub. No.: US 2006/0032904 A1
(43) Pub. Date: Feb. 16, 2006

(54) IC card creation method and system thereof

(76) Inventors: Masayoshi Kawamoto, Tokyo (JP); Takashi Deguchi, Tokyo (JP); Hisanori Matsuyama, Tokyo (JP); Masahiro Shibata, Tokyo (JP); Satoru Tanimoto, Tokyo (JP); Kei Yamaguchi, Tokyo (JP); Yumiko Kawato, Tokyo (JP)

Correspondence Address: SHLESINGER, ARKWRIGHT & GARVEY LLP, 1420 KING STREET, SUITE 600, ALEXANDRIA, VA, 22314, US

(21) Appl. No.: 10/501,923

(22) PCT Filed: Feb. 19, 2003
(86) PCT No.: PCT/JP03/01779

§ 371 Date: Jul. 6, 2005

(30) Foreign Application Priority Data
Feb. 20, 2002 (JP) 2002-42842

(51) Int. Cl. G06K 5/00

(52) U.S. Cl. 235/380

(57) ABSTRACT

An IC card creation entrusted company server for creating IC card creation data to be loaded on an IC card registers in advance in-advance registration information data including at least one or more application template information mountable on a IC card, receives IC car setting data consisting of card basis information data including personal information and IC card unique information specification data including one or more application specification information, extracts template information registered in advance for each application corresponding to the application specification information contained in the IC card setting data, creates load data of each application, and merges load data of each application, thereby creating IC card creation data.

### BACKGROUND OF THE INVENTION

The present invention relates to a method of creating an IC card and a system for creating an IC card for use in each of monetary facilities, enterprises, or various organizations.

Although a magnetic card is conventionally used as a money or cash card which is issued by a monetary facility such as a banking company, an IC card is on the road to be used as the money card. It is possible to realize a high function in an IC money card, inasmuch as the IC money card includes an IC chip. More particularly, it is possible to make the IC card have a multi-application function, a dynamic loading function, and a multi-issue function in addition to a money card function. The multi-application function includes a function as a reward card or an electronic money card. By using the dynamic loading function, it is possible to add other card functions to the IC card by an ATM terminal device, after issuing the IC card. By using multi-issue function, it is possible to integrate card functions which are issued by a plurality of issuers, respectively, to the IC card. Furthermore, it is possible to remarkably improve security in the IC card in comparison to the magnetic card.

However, There are following problems in which a highly functional IC money card is issued. Inasmuch as the IC card has a plurality of functions, it is necessary to establish information concerned to the functions, at each card and to manage the information. More specifically, the information may be, for example, application information for endowing each function, operating system (OS) information, IC chip information, each version information, and key information. On issuing the IC card, that is, on physically creating the IC card, it is necessary to establish the above-mentioned information in the IC card. When establishing the information in the IC card, it is necessary to repeat data transmission and reception between an IC card issuer and a plurality of application providers. In addition, it is necessary for the IC card issuer to specify establishing contents and to adjust the establishing contents. Therefore, an IC card issuing process becomes very complex and difficult in comparison to a magnetic card issuing process. Under the circumstances, cost increases on issuing the IC card.

### SUMMARY OF THE INVENTION

In order to taking the above-mentioned problems into consideration, it is an object of the present invention to provide an IC card creating method and an IC card creating system capable of reducing a load of IC card issuing service in an IC card issuing enterprise and capable of reducing an IC card issuing cost.

In order to accomplish the above-mentioned object, according to a first aspect of the present invention, there is provided a method of creating an IC card wherein an IC card creation entrusted company server for creating IC card creation data to be loaded to an IC card previously registers advance registration information data which includes at least one template information in relation to at least one application stored in the IC card. The IC card creation entrusted company server receives IC card setting data composed of card basic information data including individual information and IC card unique information assigning data including at least one application assigning information and takes out the template information which is previously registered with respect to each application, in accordance with the application assigning information which is included in the IC card setting data. The IC card creation entrusted company server combines the card basic information data with the taken template information to create loading data with respect to each application and merges the loading data of each application to produce the IC card creation data.

According to a second aspect of the present invention, the IC card creation entrusted company server loads the IC card creation data to an chip of the IC card to create the IC card.

According to a third aspect of the present invention, the IC card creation entrusted company server receives said IC card setting data from at least one IC card issuing company server to produce the IC card creation data, and transmits the produced IC card creation data to the at least one IC issuing company server.

According to a fourth aspect of the present invention, there is provided a system for creating an IC card wherein an IC card creation entrusted company server for creating IC card creation data to be loaded to an IC card comprises a database for previously registering advance registration information data which includes at least one template information in relation to at least one application stored in the IC card. The IC card creation entrusted company server comprises receiving means for receiving IC card setting data composed of card basic information data including individual information and IC card unique information assigning data including at least one application assigning information and taking means for taking out said template information which is previously registered with respect to each application, in accordance with the application assigning information which is included in said IC card setting data. The IC card creation entrusted company server comprises combining means for combining the card basic information data with the taken template information to create loading data with respect to each application and merging means for merging the loading data of each application to produce the IC card creation data.

According to a fifth aspect of the present invention, the IC card creation entrusted company server further comprises loading means for loading the IC card creation data to an chip of the IC card to create the IC card.

According to a sixth aspect of the present invention, the IC card creation entrusted company server comprises reception means for receiving the IC card setting data from at least one IC card issuing company server to produce said IC card creation data and transmission means for transmitting the produced IC card creation data to the at least one IC issuing company server.

According to a seventh aspect of the present invention, there is provided a program for creating an IC card wherein an IC card creation entrusted company server for creating IC card creation data to be loaded to an IC card comprises the functions of previously registering advance registration information data which includes at least one template information in relation to at least one application stored in the IC card, receiving IC card setting data composed of card basic information data including individual information and IC card unique information assigning data including at least one application assigning information, taking out the template information which is previously registered with respect to each application, in accordance with the application assigning information which is included in the IC card setting data, combining the card basic information data with the taken template information to create loading data with respect to each application, and merging the loading data of each application to produce the IC card creation data.

### BRIEF DESCRIPTION OF THE DRAWINGS

FIG. 1 is a configuration for roughly illustrating an example of a business mode to which an IC card creating method according to the present invention is applicable;

FIG. 2 is a configuration for illustrating an embodiment of IC card creating method which is applicable to the business mode illustrated in FIG. 1; and

FIG. 3 shows a view for illustrating an example of processing steps of IC card creating data in an IC card creation entrusted company.

### PREFERRED EMBODIMENTS OF THE INVENTION

Description will be made as regards an embodiment according to the present invention with reference to drawings.

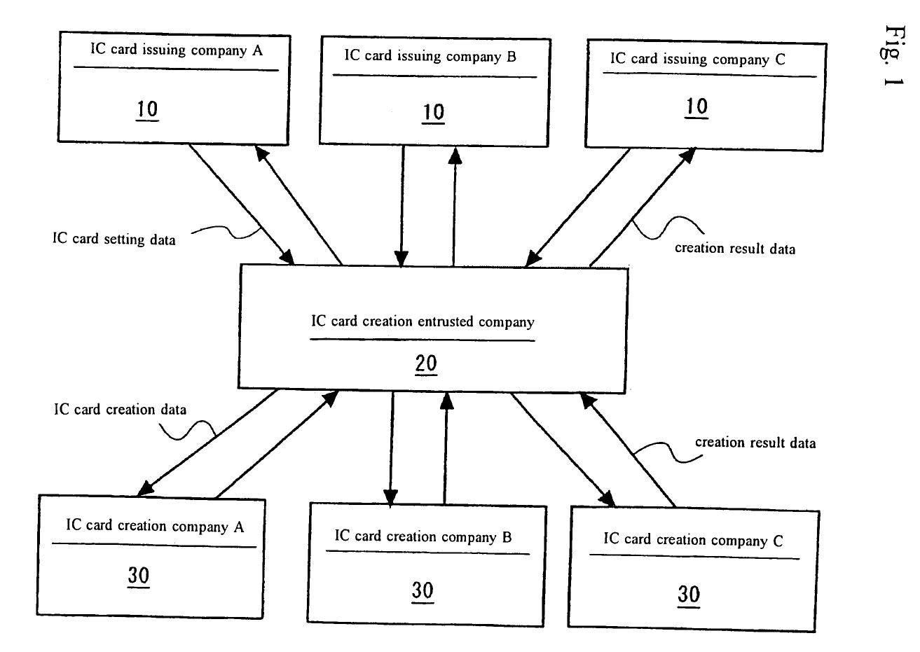

FIG. 1 is a configuration for roughly illustrating an example of a business mode to which an IC card creating method according to the present invention is applicable. Each of a plurality of IC card issuing companies A, B, and C may be, for example, a credit company or a monetary facility such as a banking company. Each of the IC card companies creates an individual card such as a money card or a credit card heretofore and issues the individual card. In case where each of the above-mentioned card issuing companies issues the money card or the credit card in a fashion of the IC card, each of the card issuing companies supplies an IC card creation entrusted company 20 with setting data which includes information necessary for realizing the function of the IC card, in order to entrust an IC card creation. The setting data have information for use in assigning an application for realizing various functions of the IC card. In addition, the setting data have individual data necessary to issue the IC card and card designing information. In other words, the setting data includes entire information which is necessary to physically create the IC card.

The IC card creation entrusted company 20 creates IC card creation data which are loaded to an IC chip included in the IC card, in accordance with the supplied setting data. The IC card creation entrusted company 20 supplies an IC card creating company 30 with the created IC card creation data. The IC card creating company 30 may be, for example, a printing company which carries out a card creating business until now. Accordingly, it is possible to select one of the printing companies as the IC card creating company 30. The IC card creating company 30 loads the supplied IC card creation setting data such as the card designing information is supplied to the IC card creating company 30 in addition to the IC card creation data, in order to create the IC card entrusted on the basis of the above-mentioned setting data.

Although the IC card creation entrusted company 20 creates the IC card creation data and entrusts an actual IC card creating process to the IC card creating company 30 in the example being illustrated in FIG. 1, the IC card creating company 30 may be integrated in the IC card creation entrusted company 20 in another business mode. In this case, the IC card creation entrust company 20 deals with an entire process until the IC card is created. In a still other business mode, the IC card issuing company 10 may create the IC card. In this case, IC card creation entrusted company 20 creates the IC card creation data and supplies the IC card creation data to the IC card issuing company 10. The IC card issuing company 10 carries out the IC card creating process.

After creating the IC card, the IC card creating company 30 collects IC card creating result data to answer the IC card creating result data to the IC card creation entrusted company 20. The IC card creation entrusted company 20 answers the IC card creating result data to the IC card issuing company 10, in order to carry out an IC card issuing management in the IC card issuing company 10. Although it is possible for the IC card creating company 30 to directly answer the IC card creating result data to the IC card creating company 10, it is desirable that the IC card creation entrusted company 20 functions as a center for intensively managing the information between a plurality of IC card issuing companies and the a plurality of IC card creating companies, in the business mode illustrated in FIG. 1.

Incidentally, servers are provided in IC card issuing company 10, the IC card creation entrusted company 20, and the IC card creating company 30, respectively, in order to realize the functions of the IC card issuing company 10, the IC card creation entrusted company 20, and the IC card creating company 30, in the embodiment of the method according to the present invention. More particularly, the above-mentioned functions of each company are realized in programs which run in the servers of the IC card issuing company 10, the IC card creation entrusted company 20, and the IC card creating company 30, respectively.

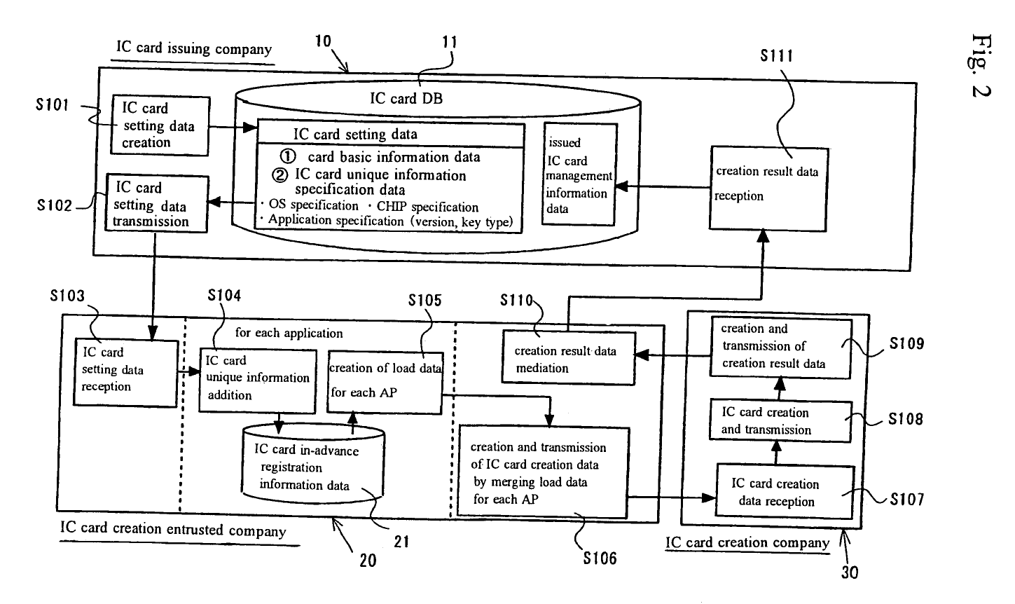

FIG. 2 is a configuration for illustrating an embodiment of IC card creating method which is applicable to the business mode illustrated in FIG. 1. Description will be made with reference to steps S101 to S111 of FIG. 2.

At a step S101, the IC card creating company 10 creates the IC card setting data for use in issuing a new IC card. The IC card setting data is established in accordance with a contract content related to a customer which becomes an IC card holder. At first, the IC card setting data have card basic information data which are necessary without regard to IC card. For example, the card basic information data includes individual information (such as a full name and an ID number) of the IC card holder. Secondly, it is necessary to include unique information for the IC card, in the IC card setting data. In order to make the IC card function as the money card, the reward card, and/or the electronic money card, it is necessary to load an application (AP) program for use in realizing the functions, in the IC chip. In addition, various sorts of operating systems (OS) are known each of which carries out the above-mentioned application program. Furthermore, it is possible to select one of a various sorts of IC chips. The application programs may be different in versions from one another. It is necessary to determine the version of the necessary application program. Therefore, the information for assigning the sorts and versions of the necessary application program, the operating system, and the IC chip is selected as IC card unique information assigning data which is added to the IC card setting data. For example, a table in which codes are assigned with respect to selections of the application programs is created in advance. By including the code of the necessary application program to the IC card setting data, it is possible to assign the necessary application program. Incidentally, the IC card creation entrusted company, which will be described hereinafter, shares the selection table with the IC card issuing company 10, in case where the above-mentioned selection table is produced. The IC card setting data, which is created or produced in the above-mentioned manner, are stored or memorized in an IC card data base which is provided in the IC card issuing company 10, in order to carry out the IC card issuing management.

At a step S102, the IC card issuing company 10 transmits the IC card setting data to the IC card creation entrusted company 20. By the data transmission, the IC card issuing company 10 entrusts the IC card creation to the IC card creation entrusted company 20. The servers in the IC card issuing company 10 and the IC card creation entrusted company 20 have functions for transmitting the data to each other through a communication network. Incidentally, the data transmission may be carried out through an electronic data recording medium such as a magnetic tape, in another embodiment.

At a step S103, the IC card creation entrusted company 20 receives the IC card setting data from the IC card issuing company 10.

At a step S104, the IC card creation entrusted company 20 creates program data which is actually loaded to the IC chip of the IC card, in accordance with the IC card setting data. The IC card setting data have the information which for use in assigning each application program memorized in the IC card. In accordance with the application assigning information, the IC card unique information is added to the IC card with respect to each application program.

At a step S105, loading data is produced with respect to each application program.

At a step S106, the IC card creation data, which is program data actually loaded to the IC chip, is produced or created, by merging the loading data related to each application program. The produced IC card creation data is transmitted to the IC card creating company 30.

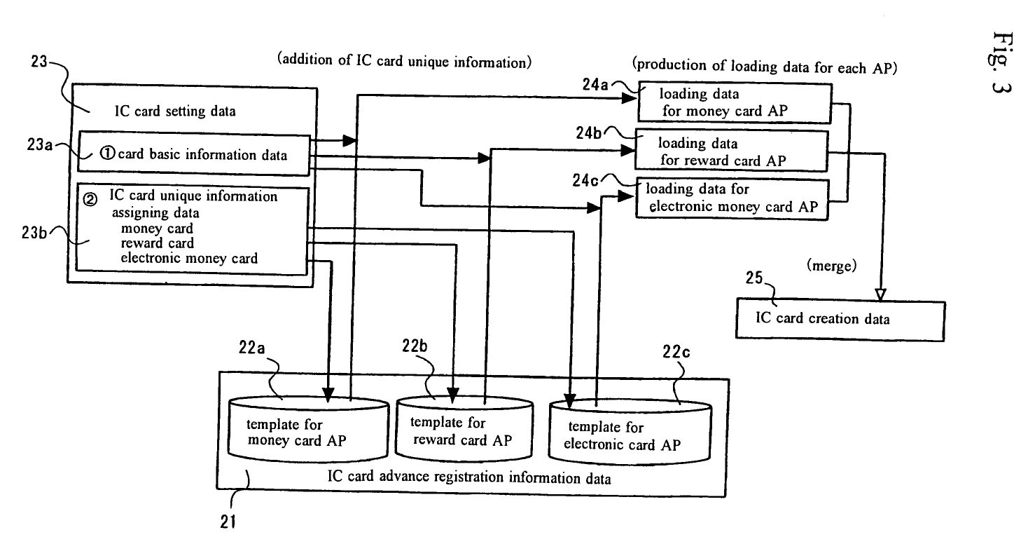

FIG. 3 shows a view for illustrating an example of processing steps S104 to S106 of IC card creating data in the IC card creation entrusted company 20. In case where the data (such as codes) for assigning the money card, the reward card, and the electronic money card are included in the IC card unique information assigning data 23b which is included in the received IC card setting data 23, templates (models) related to the card function application programs are taken out by referring to the IC card previous record information database 21 which is kept in advance. The templates 22a, 22b, and 22c related to the application programs are provided from the IC card issuing company 10 in advance and are registered in the IC card previous record information database 21. By combining the IC card basic information data of the creating IC card with the templates which are taken out from the IC card previous record information database 21, the templates are specified. In the manner described above, the loading data 24a, 24b, and 24c are created with respect to application programs, respectively. In addition, a specific individual establishment is combined to the IC card basic information data in case where the specific individual establishment exists in each application program. For example, the specific individual establishment may be an establishment of an available limit amount. Finally, merging the application programs produces the IC card creation data.

At a step S107, the IC card creating company 30 receives the IC card creation data with reference to FIG. 2. Incidentally, the IC card creating company 30 further receives the other necessary information data which may be, for example, the card designing information.

At a step S108, the IC card creating company 30 loads the IC card creation data to the IC chip of the IC card and completes the IC card on the basis of the other information such as the card designing information which is included in the IC card setting data. Incidentally, the IC card creating company 30 delivers the IC card to the customer, in case where the IC card creating company 30 is entrusted to deliver the IC card to the customer.

At a step S109, the IC card creating company 30 collects the information related to the IC card creation, to produce IC card creation result data which are answered to the IC card creation entrusted company 20. For example, the IC card creation result data have a customer ID number and a serial number of the IC card.

At a step S110, the IC card creation entrusted company 20 receives the IC card creation result data and transmits the IC card creation result data to the IC card issuing company 10.

At a step S111, the IC card issuing company 10 receives the IC card creation result data and registers the IC card creation result data in the IC card database, in order to utilize the IC card creation result data with respect to the card issuing management.

As described above, a plurality of IC card issuing companies 10 previously register application templates which are possible to be stored in IC cards to be issued, to the database of the IC card creation entrusted company 20, in the IC card creating method according to the present invention. On issuing the IC card, each of the IC card issuing companies 10 transmits the IC card setting data which assign the applications to be stored in the IC card, to the IC card creation entrusted company 20. The IC card creation entrusted company 20 creates loading data with respect to each application with reference to each template, on the basis of the IC card setting data. Furthermore, the IC card creation entrusted company 20 merges the loading data to produce the IC card creation data. It is possible to create the IC card by loading the IC card creation data to the IC chip.

According to the present invention, it is possible to reduce the IC card issuing cost inasmuch as each of the IC card issuing companies can omit a part of entire process for creating the IC card.

In addition, it is possible to flexibly combine the applications inasmuch as the applications are easily selected when assigning the applications stored in the IC card.

1-7. (canceled)

8. A method of creating an IC card that is carried by an IC card creation entrusted company server, wherein:
said IC card creation entrusted company server previously registers advance registration information data which include at least one template information in relation to at least one application stored in the IC card;
said IC card creation entrusted company server receiving IC card setting data composed of card basic information data including individual information and IC card unique information assigning data including at least one application assigning information;
said IC card creation entrusted company server taking out said template information which is previously registered with respect to each application, in accordance with said application assigning information which is included in said IC card setting data;
said IC card creation entrusted company server combining said card basic information data with the taken template information to create loading data with respect to each application; and
said IC card creation entrusted company server merging the loading data of each application to produce the IC card creation data.

9. A method of creating an IC card that is carried by an IC card creation entrusted company server and an IC card creation company server, wherein:
said IC card creation entrusted company server previously registers advance registration information data which include at least one template information in relation to at least one application stored in the IC card;
said IC card creation entrusted company server receiving IC card setting data composed of card basic information data including individual information and IC card unique information assigning data including at least one application assigning information;
said IC card creation entrusted company server taking out said template information which is previously registered with respect to each application, in accordance with said application assigning information which is included in said IC card setting data;
said IC card creation entrusted company server combining said card basic information data with the taken template information to create loading data with respect to each application;
said IC card creation entrusted company server merging the loading data of each application to produce the IC card creation data;
said IC card creation entrusted company server transmitting said IC card creation data to said IC card creation company server; and
said IC card creation company server loading said IC card creation data to an chip of the IC card to create the IC card.

10. A system for creating an IC card that comprises an IC card creation entrusted company server, wherein said IC card creation entrusted company server comprises:
a database for previously registering advance registration information data which includes at least one template information in relation to at least one application stored in the IC card;
receiving means for receiving IC card setting data composed of card basic information data including individual information and IC card unique information assigning data including at least one application assigning information;
taking means for taking out said template information which is previously registered with respect to each application, in accordance with said application assigning information which is included in said IC card setting data;
combining means for combining said card basic information data with the taken template information to create loading data with respect to each application;
merging means for merging the loading data of each application to produce the IC card creation data; and
transmitting means for transmitting said IC card creation data to said IC card creation company server;
said IC card creation company server comprising loading means for loading said IC card creation data to a chip of the IC card to create said IC card.

11. A program for creating an IC card, wherein an IC card creation entrusted company server comprises the functions of:
previously registering advance registration information data which includes at least one template information in relation to at least one application stored in the IC card;
receiving IC card setting data composed of card basic information data including individual information and IC card unique information assigning data including at least one application assigning information;
taking out said template information which is previously registered with respect to each application, in accordance with said application assigning information which is included in said IC card setting data;
combining said card basic information data with the taken template information to create loading data with respect to each application;
merging the loading data of each application to produce the IC card creation data; and
loading said IC card creation data to a chip of the IC card to create said IC card.
